(19) United States
(12) Patent Application Publication
(10) Pub. No.: US 2012/0009387 A1
(43) Pub. Date: Jan. 12, 2012

(54) FLEXIBLE THERMOPLASTIC FILMS AND ARTICLES

(76) Inventors: James H. Wang, Appleton, WI (US); Peter M. Clark, Grand Rapids, MI (US); Yiwu Guan, Mosman (AU); Yan Wang, Beijing (CN); Xueen George Hao, Beijing (CN); Tong-tong Zhang, Beijing (CN)

(21) Appl. No.: 13/211,572

(22) Filed: Aug. 17, 2011

(30) Foreign Application Priority Data
May 15, 2009 (CN) 200910146604.6
Apr. 15, 2010 (IB) PCT/IB2010/051652

(51) Int. Cl. B32B 3/00; B32B 27/32; C08K 13/02; C08K 11/00; C08K 5/1545; C08K 9/04; B32B 5/00; C08L 23/06

(52) U.S. Cl. 428/141; 428/220; 524/52; 524/9; 524/50; 524/51

(57) ABSTRACT

A biodegradable, polyolefin-based material composition having incorporated therein thermoplastic starch particles is described. The material includes from about 5% to about 45% of a thermoplastic starch (TPS), from about 55% to about 95% of a polyolefin or mixtures of polyolefins, and from about 0.5% to about 8% of a compatibilizer, which has a non-polar backbone and a polar functional monomer or a block copolymer of both the non-polar block and a polar block. A method of forming a film and packaging assemblies made with the polymeric material are also described.

### FIELD OF INVENTION

The present invention relates to a composition for flexible polyolefin-based films that contain thermoplastic starches. In particular, the invention pertains to packaging films that include polyolefins, renewable polymers, and a compatibilizer, and describes a method to overcome their material incompatibility to make packaging films of desirable physical and mechanical properties.

### BACKGROUND

In recent years as petroleum resources become more scarce or expensive and manufacturers and consumers alike have become more aware of the need for environmental sustainability, interest in bio-degradable and renewable films containing renewable and or natural polymers for a variety of uses has grown. Renewable polymers available today, such as polylactic acid (PLA), polyhydroxyalkanoate (PHA), thermoplastic starch (TPS), etc., however, all have deficiencies in making thin, flexible packaging films such that are typically used as packaging films for bath tissues, facial tissue, wet wipes and other consumer tissue products, product bags for personal care products, away-from-home products, and health care products. For instance, PLA thin film exhibits a high stiffness and very low ductility, sometimes costly bi-axial stretching process is used to produce thin PLA films, which results in relatively high rustling noise levels when handled and very brittle films, making the material unsuitable for flexible thin film packaging uses. PHA is difficult to make into thin films. Poor film processability (i.e., slow crystallization, extreme stickiness prior to solidification) retards fabrication-line speeds that result in relatively expensive production costs. Some PHA such as poly-3-hydroxybutyrate (PHB), poly-3-hydroxybutyrate-co-3-hydroxyvalerate (PHBV) films have high stiffness and low ductility, making them not suitable for flexible thin film applications. TPS film has a low tensile strength, low ductility, and also severe moisture sensitivity. TPS also has difficulty to make thin films due to its low melt strength and extensibility making TPS not suitable for stand-alone packaging film applications unless using expensive blends with compatible biodegradable polymers, such as Ecoflex™, an aliphatic-aromatic copolyester by BASF AG.

Common existing packaging equipment are optimal for converting polyethylene-based films, efforts to replace or upgrade the packaging hardware to run 100% renewable polymers can require high capital expenditures. The poor processability of 100% renewable polymers also increases production cost due to reduced line speed, etc. Therefore, there is a need for thin packaging films containing a renewable polymer to reduce the carbon foot print and improve environmental benefits at an affordable cost. The packaging films must have good performance required for packaging applications in terms of heat seal, tensile properties, and free of any visible defects, and suitability for high speed packaging applications.

### SUMMARY OF THE INVENTION

The present invention addresses a need for a flexible polymeric film that is better or improved over conventional polyolefin films in terms of its environmental impact. The use of renewable materials in films and utilizing natural or new carbon or recently fixed CO₂ by removing it from the atmosphere, can slightly reduce global warming effects. The production of the present inventive films can reduce energy input and green house gas emission. The relative degree of biodegradation is partial pending on the amount of biodegradable component present in the films, but it is more biodegradable than pure polyolefin thin films.

In general, the invention describes a flexible polymeric film having from about 5% to about 45% of a thermoplastic starch (TPS), from about 55% to about 95% of a polyolefin or mixtures of polyolefins, and from about 0.5% to about 8% of a compatibilizer, which has a non-polar backbone and a polar functional monomer, or a block copolymer of both the non-polar block and a polar block, or a random copolymer of a non-polar monomer and a polar monomer. The amounts of said thermoplastic starch and compatibilizer, respectively, can be present in a ratio of between about 7.5:1 to about 95:1. Typically, the ratio of said thermoplastic starch and compatibilizer, respectively, is between about 10:1 and about 55:1. More typically, the ratio of said thermoplastic starch and compatibilizer, respectively, is between about 15:1 and about 50:1.

The invention relates, in part, to a method of forming a polymeric film, the method comprising: preparing a polyolefin mixture, blending said polyolefin mixture with a thermoplastic starch and a compatibilizer, which has a non-polar backbone and a polar functional monomer or a block copolymer of both the non-polar block and a polar block, said thermoplastic starch and compatibilizer, respectively, are present in amounts in a ratio of between about 7.5:1 to about 95:1; extruding said film of said blended polyolefin mixture.

In another aspect the present invention pertains to a packaging material or assembly made from the polymeric film composition such as described. The film can be fabricated to be part of a packaging assembly. The packaging assembly can be used to wrap consumer products, such as absorbent articles including diapers, adult incontinence products, pantiliners, feminine hygiene pads, or tissues. In other iterations, the invention relates to a consumer product having a portion made using a flexible polymeric film, such as described. The polymeric film can be incorporated as part of consumer products, e.g., baffle films for adult and feminine care pads and liners, outer cover of diapers or training pants.

Additional features and advantages of the present invention will be revealed in the following detailed description. Both the foregoing summary and the following detailed description and examples are merely representative of the invention, and are intended to provide an overview for understanding the invention as claimed.

### BRIEF DESCRIPTION OF FIGURES

FIG. 1 is a representation of the molecular structure of Amylopectin.

FIG. 2 is a representation of the molecular structure of Amylose.

FIG. 3 shows a photo of a comparative example of a film formed from a blend of 80% polyethylene and 20% TPS, having undispersed TPS aggregates (white dots) and holes that have developed due to the stretching in the machine direction.

FIG. 4 shows a photo of another comparative example of a film similar to that of FIG. 3. The film has 30% TPS blended with 70% polyethylene, exhibiting a greater number of undispersed starch aggregates and large holes in the film.

FIG. 5 is the molecular structure of a grafted copolymer of a polyolefin (DuPont Fusabond® MB-528D).

FIG. 6 shows a photo of an example of a film according to the present invention that is blended with a compatibilizer. The undispersed TPS that was previously seen in the films of FIGS. 3 and 4 are nonexistent in this example of the film composition.

FIG. 7 shows another example of a film according to the present invention that is blended with a compatibilizer. Similar to FIG. 6, the film exhibits little evidence of undispersed starch aggregates and no holes. The starch was fully homogenized up to about 40-45%.

FIG. 8 is a graph that shows the dispersion region for relative incorporated amounts of compatibilizer as a function of the polyolefin content in several different blends.

FIG. 9 is a graph of the moduli of five film samples with different levels of TPS incorporation.

FIG. 10 is a graph that summarizes the peak stress of the five films of FIG. 9.

FIG. 11 is a graph that summarizes the elongation of the five films of FIGS. 9 and 10.

FIG. 12 is a graph that presents the energy required to break of film samples according to the invention, along machine direction (MD) and cross-direction (CD) stretching.

FIG. 13 is a graph that presents the moduli of four 60% PE, 40% TPS films that were blended with different percentage amounts of compatibilizer (Fusabond® MB-528D).

FIG. 14 is a graph that shows the peak stresses of the same four blends of FIG. 13.

FIG. 15 is a graph that shows the relative elongation of the four blends of FIG. 13.

FIG. 16 is a graph that shows the break energy of the films made from the four blends of FIG. 13.

### DETAILED DESCRIPTION OF THE INVENTION

### Section I—Definition

The term “biodegradable,” as used herein, refers generally to a material that can degrade from the action of naturally occurring microorganisms, such as bacteria, fungi, yeasts, and algae; environmental heat, moisture, or other environmental factors. If desired, the extent of biodegradability may be determined according to ASTM Test Method 5338.92.

The term “renewable” as used herein refers to a material that can be produced or is derivable from a natural source which is periodically (e.g., annually or perennially) replenished through the actions of plants of terrestrial, aquatic or oceanic ecosystems (e.g., agricultural crops, edible and non-edible grasses, forest products, seaweed, or algae), or microorganisms (e.g., bacteria, fungi, or yeast).

### Section II—Description

The present invention enables manufacturers to make use of a majority of polyolefin compounds to achieve good processing characteristics and mechanical properties at low cost. The present invention describes a composition for and method of making thin packaging films for consumer packaged goods with suitable performance, renewable polymer content to reduce their environmental footprint, and at an attractive cost. The composition incorporates renewable polymers such as thermoplastic starch as a renewable component. The amount of renewable polymers has to be at a volumetric minority so the polyolefins properties will dominate the blend properties. An appropriate type of plasticizer at the right amount must be employed to compatibilize the two phases to create an adequate dispersion and good film properties.

It was surprisingly found that a range of intermediate compositions allow the blends to be compatibilized and have good physical and mechanical properties. An unexpected region of tertiary composition was found to have good mechanical properties, good processability, and free from any visible defects. Outside of the compositions, gelled phases of either TPS or compatibilizer formed resulting in poor mechanical properties, visual defects, and making the films unsuitable for packaging applications. Outside of this region, with too little of compatibilizer, the renewable polymers (TPS) existed as un-dispersed gels leading to granular defects unsuitable for thin packaging film applications and visible voids/holes; above the range of the optimal compatibilizer composition, the compatibilizer formed its own gelled phase and defects. The other aspect of this invention is the polyolefins in the film material can be processed relatively easily and achieves good tensile strength and cohesive properties that allow packaging films to be produced at no productivity penalty or slow down in converting process. Also disclosed in this invention is multiple-layered co-extruded flexible packaging films with one or more layer of the above films and one or more layer of polyethylene or mixed polyethylene layers, the presence of polyethylene layer provides excellent sealability, printability, and mechanical properties required for packaging consumer packaged goods.

In comparison to conventional polyolefin-based films, the inventive polymeric film is much softer and expected to be more breathable to moisture to keep a user's skin drier. When the present films are employed in an absorbent article, such as a baffle film in a diaper, the film will feel more comfortable against the user's skin as a consequence of a more micro-grainy or micro-textured surface, and will not have as slippery or rubbery a feeling as conventional polyethylene-based films.

The thermoplastic starch in the polymeric film comprises either a native starch or a modified starch with a plasticizer. The native starch can be selected from corn, wheat, potato, rice, tapioca, cassava, etc. The modified starch can be a starch ester, starch ether, oxidized starch, hydrolyzed starch, hydroxyalkylated starch, etc. Genetically modified starch can also be used; such modified starch may have a different ratio from that of amylose and amylopectin. Mixtures of two or more different types or modifications can also be used in this invention. The thermoplastic starch and the polyolefin do not chemically bond with each other.

The thermoplastic starch may include a plasticizer or mixture of two or more plasticizers selected from polyhydric alcohols including glycerol, glycerine, ethylene glycol, polyethylene glycol, sorbitol, citric acid and citrate, aminoethanol. In certain embodiments, the concentration of starch in the film may be from about 45 wt. % or 50 wt. % to about 85 wt. % or 90 wt. %. One may include proportionate amounts of mixed starches of different origins or types (e.g., starches selected from corn, wheat, potato, rice, tapioca, cassava, etc.). According to certain other embodiments, the amount of thermoplastic starch and plasticizer present may include from about 60 or 65 wt. % to about 70 or 75 wt. % starch, and from about 10 or 15 wt. % to about 30 or 40 wt. % plasticizers, inclusive of any combination of ranges there between.

Thermoplastic starch biodegradable plastics (TPS) have a starch (amylose) content greater than 70% and are based on gelatinised vegetable starch, and with the use of specific plasticizing solvents, can produce thermoplastic materials with good performance properties and inherent biodegradability. Starch is typically plasticised, destructured, and/or blended with other materials to form useful mechanical properties. Importantly, such TPS compounds can be processed on existing plastics fabrication equipment.

High starch content plastics are highly hydrophilic and readily disintegrate on contact with water. This can be overcome through blending, as the starch has free hydroxyl groups which readily undergo a number of reactions such as acetylation, esterification and etherification, etc.

The resulting flexible film includes about 5% to about 45% of a renewable polymer such as thermoplastic starch (TPS), from 55% to 95% of a polyolefin or mixtures of polyolefins, and from 0.5% to 8% of a compatibilizer which has a non-polar backbone and a grafted polar functional monomer or a block copolymer of a both the non-polar block and a polar block.

According to alternate embodiments, the flexible polymeric film may incorporate as part of a master batch from about 5% to about 45% of a thermoplastic starch concentrate, from about 40% to 55% of a polyolefin, and from about 1% to about 15% of a color concentrate. The color concentrate can be added to make the otherwise clear film opaque or white. The colorant may include, for instance, various dyes, titanium oxide, calcium carbonate, or opacifiers such as clays, etc. Thermoplastic starch concentrate can have from about 50% to about 90% by weight starch, from about 5 to about 40% a polyolefin, and from about 0.5 to about 5% a compatibilizer.

Examples of the polyolefins that may be incorporated include low-density polyethylene, high-density polyethylene, linear low-density polyethylene, polyolefin elastomers such as Vistmaxx from Exxon Mobil, or ethylene copolymers with vinyl acetate, or methacrylate, etc. The compatibilizer may include: ethylene vinyl acetate (EVA), ethylene vinyl alcohol (EVOH), polymer ethylene-co-acrylic acid, and a graft copolymer of non-polar polymer grafted with a polar monomer such as a polyethylene grafted with maleic anhydride. The polar functional monomer is maleic anhydride, acrylic acid, vinyl acetate, vinyl alcohol, amino, amide, or acrylate. The polar functional monomer may be present in an amount that ranges from about 0.1% or 0.3% to about 40% or 45% by weight; desirably, about 0.5 wt. % or 1 wt. % to about 35 wt. % or 37 wt. %, inclusive. Mixed polyethylenes or polyethylene/polypropylene blends can also be used in this invention. The composition may also contain from about 0.5% to about 30% of a biodegradable polymer.

The polymeric film can include a mineral filler that is present in an amount from about 5% or 8% to about 33% or 35% by weight, inclusive. Typically, the mineral filler is present in an amount from about 10% or 12% to about 25% or 30% by weight. The mineral filler may be selected from any one or a combination of the following: talcum powder, calcium carbonate, magnesium carbonate, clay, silica, alumina, boron oxide, titanium oxide, cerium oxide, germanium oxide, etc.

The polymeric films and packaging can have multiple layers, for instance, from 1 to 7 or 8 layers; or in some embodiments, between about 2 or 3 to about 10 layers. The combined polymeric film layers can have a thickness of ranging from about 0.5 mil to about 5 mil, typically from about 0.7 or 1 mil to about 3 or 4 mil. Each layer can have a different composition, but at least one of the layers is formed from the present film composition. The at least one layer is formed with a thermoplastic starch concentrate such as a blend of thermoplastic starch, polyethylene and a compatibilizer with the high thermoplastic starch content, in some cases the TPS content can range from 50 to 90% by weight. The polyethylene in the layer can be low density polyethylene, linear low density polyethylene, high density polyethylene or ethylene copolymers, or mixtures of polyolefins. At least one layer on the seal side is polyethylene layer. Alternatively, a polymeric flexible film layer has a thickness from about 10 or 15 micrometers to about 90 or 100 micrometers. Typically, the film has a thickness from about 15 or 20 micrometer to about 45 or 50 micrometers. Desirably, the film thickness is about 15 to about 35 micrometers.

Generally, the flexible polymeric film according to the invention exhibits a modulus from about 50 MPa to about 300 Mpa, and a peak stress ranges from about 15 MPa to about 50 MPa, at an elongation of from about 200% to about 1000% of original dimensions. Typically, the modulus is in a range from about 55 or 60 MPa to about 260 or 275 MPa, and more typically from about 67 or 75 MPa to about 225 or 240 MPa, inclusive of any combination of ranges there between. Typically, the peak stress can range from about 20 or 23 MPa to about 40 or 45 MPa, inclusive of any combination of ranges there between.

The polymeric film will tend to have a micro-textured surface with topographic features, such as ridges or bumps, of between about 0.5 or 1 micrometers up to about 10 or 12 micrometers in size. Typically the features will have a dimension of about 2 or 3 micrometers to about 7 or 8 micrometers, or on average about 4, 5, or 6 micrometers. The particular size of the topographic features will tend to depend on the size of the individual starch particles, and/or their agglomerations.

In contrast to others, that describe rigid injection molding products, the present invention can be used to create flexible polyolefin-based films based on polyethylene and TPS (preformed), and a plasticizer, which are more suited to the specific requirements of packaging films.

In another aspect, the invention describes a method of forming a polymeric film. The method comprising: preparing a polyolefin mixture, blending said polyolefin mixture with a thermoplastic starch and a compatibilizer, which has a non-polar backbone and a polar functional monomer or a block copolymer of both the non-polar block and a polar block or a random copolymer, said thermoplastic starch and compatibilizer, respectively, are present in amounts in a ratio of between about 7.5:1 to about 95:1; extruding said a film of said blended polyolefin mixture. Desirably, the compatibilizer includes a graft copolymer of polyethylene and maleic anhydride.

Alternatively, the method of forming a polymeric film may include the steps of preparing a polyolefin mixture; blending the polyolefin mixture with a thermoplastic starch concentrate; and extruding said mixture to form a film of said blended polyolefin mixture. The starch concentrate and polyolefins, respectively, are present in amounts in a ratio of between about 1:1 to about 0.1:1.

In contrast to other methods of preparing thermoplastic starch and synthetic polymer blends, no water-based suspension, evaporation step is needed in the present invention. Also, the present invention does not employ starch-polyester graft copolymers.

The following description and examples will further illustrate the present invention. It is understood that these specific embodiments are representative of the general inventive concept.

### A. Blends of Polyethylene and Thermoplastic Starch (TPS)

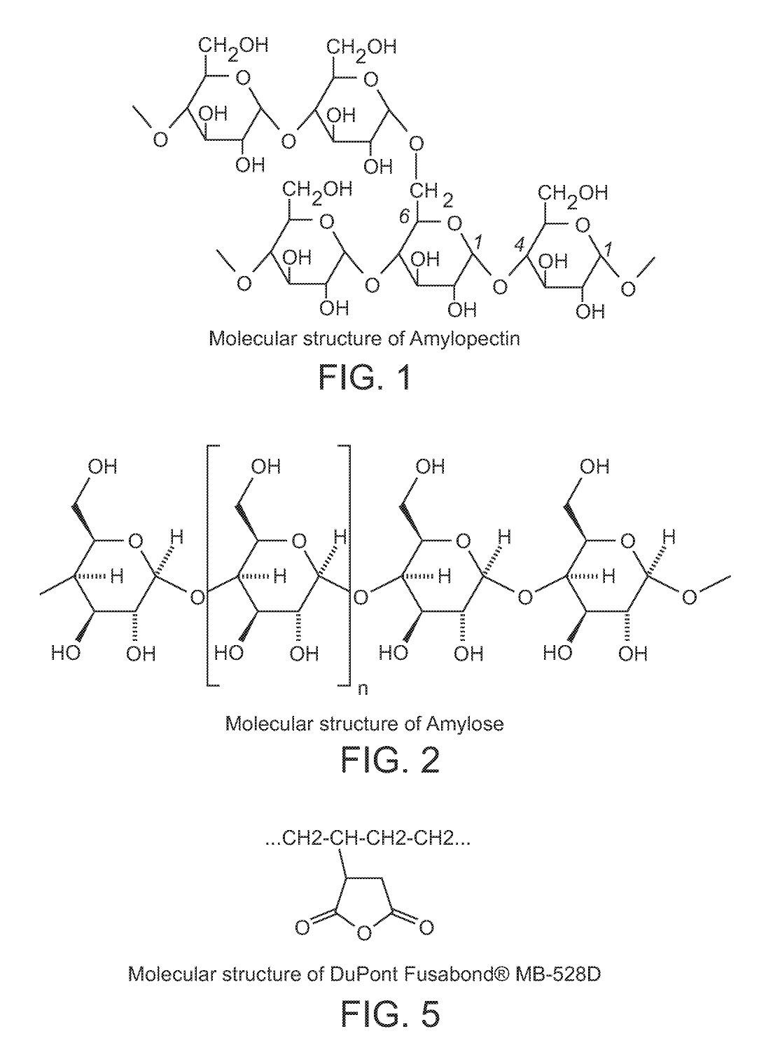

For purposes of illustration, thermoplastic starch samples are prepared with a twin-screw compounding extruder. As an example, cornstarch is incorporated at about 50 or 70 wt. % to about 85 or 90wt. %, and a plasticizer, such as glycerol or sorbitol, is added up to about 30 or 33wt. %. A surfactant, such as Excel P-40S, is added to help lubricate the thermoplastic mixture. The mixture is extruded under heat and mechanical shear to form TPS. Blending the TPS with a Maleic Anhydride Modified Polyolefin (e.g. LLDPE, LDPE, HDPE, PP, etc.) polymer produces films with un-dispersed aggregates of TPS in the films. The TPS and polyolefin are observed to be not compatible with each other in either source of TPS. An explanation appears to be found in the molecular structure of each material. The starch is comprised of two components: Amylopectin, which exists as about 70-80% of corn starch's composition, is a highly branched component of starch. Its structure is illustrated in FIG. 1. The remaining percentage (20-30%) of starch's composition is amylose, which is the mostly linear component of starch. Its structure is illustrated in FIG. 2. Both amylopectin and amylose contain a large number of hydroxyl groups and the glucose derived units are connected by oxygen atoms (i.e. ether linkages). Plant starch from different plant types can have different ratio of amylose to amylopectin.

In contrast, the molecular structure of polyethylene is a simple saturated hydrocarbon. Polyethylene do not contain any polar functional groups such as hydroxyl groups, nor are they linked by oxygen atoms. The mixing of these two components was not fully homogenous because polyethylene does not contain any polar functional groups that will cause the starch to disperse evenly throughout the film material. The films created from thermoplastic starch and polyethylene alone exhibit many undispersed starch aggregates and holes due to their incompatibility.

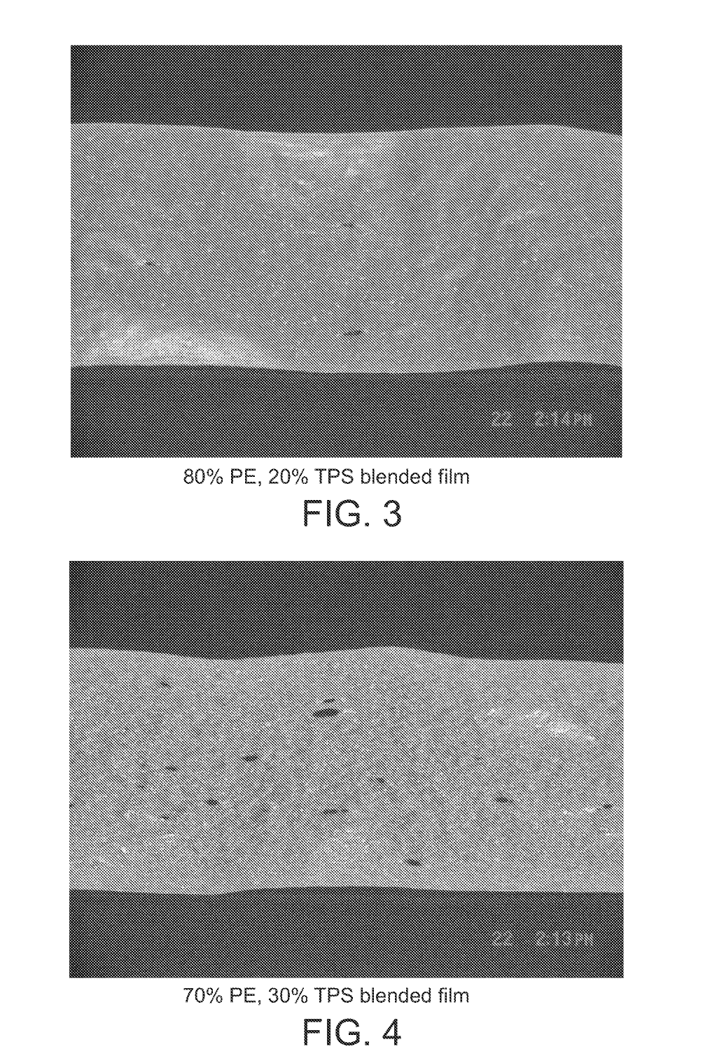

FIG. 3 shows a film blended of 80% polyethylene (PE) and 20% TPS. A number of undispersed TPS (white dots) and holes have developed due to the orientation in the machine direction by the chill roll during casting. The polyethylene will stretch, but when a chunk of undispersed starch is encountered, the starch will not stretch, and will tear a hole in the film membrane. Similar to the film shown in FIG. 3, FIG. 4 shows a film containing 30% TPS blended with 70% PE. The undispersed starch aggregates and the large number of holes in the film can be readily observed. The greater the amount of TPS that is added into the film, the worse the film becomes and the more important TPS dispersion becomes.

### B. Compatibilizers

To improve the compatibility and dispersion characteristics of TPS in polyolefins, several compatibilizers with both polar and non-polar groups are incorporated in the present invention. The compatibilizers may include several different kinds of copolymers, for example, polyethylene-co-vinyl acetate (EVA), polyethylene-co-vinyl alcohol (EVOH), polyethylene-co-acrylic (EAA), and a graft copolymer of a polyolefin (e.g., polyethylene)(e.g., DuPont Fusabond® MB-528D) and maleic anhydride based on molecular structure considerations. EVA, EVOH, EAA, etc. both have a non-polar polyethylene subunit in their backbone. The vinyl acetate subunit contains an ester group, which associated with the hydroxyls of the amylopectin and amylose. Instead of the ester group from the vinyl acetate, EVOH has a vinyl alcohol group which has hydroxyl group as in starch. Both the ester group in EVA and the hydroxyl group in EVOH do not chemically react with the hydroxyl groups starch molecules. They only associate with starch through hydrogen bonding or polar-polar molecular interactions. Using these two physical compatibilizers, TPS and EVA or EVOH blends showed improved compatibility versus the un-compatibilized PE/TPS blends.

As a graft copolymer of polyethylene and maleic anhydride, Fusabond® MB-528D has a structure shown in FIG. 5. The cyclic anhydride at one end is chemically bonded directly into the polyethylene chain. The polar anhydride group of the molecule could associate with the hydroxyl groups in the starch via both hydrogen bonding and polar-polar molecular interactions and a chemical reaction to form an ester linkage during the melt extrusion process. The hydroxyls of the starch will undergo esterification reaction with the anhydride to achieve a ring-opening reaction to chemically link the TPS to the maleic anhydride to the grafted polyethylene. This reaction is accomplished under the high temperatures and pressures of the extrusion process.

For example, the DuPont Fusabond® MB-528D, at a concentration of about 1-5% completely dispersed the thermoplastic starch in the film. The EVA and EVOH worked sufficiently well to disperse the starch particles. In comparison to the graft copolymer of polyethylene and maleic anhydride, however, EVA and EVOH, even at higher percentages of around 10 or 15%, did not fully disperse the TPS in the film. Hence, the graft copolymer of polyethylene and maleic anhydride appears to be a more effective compatibilizer.

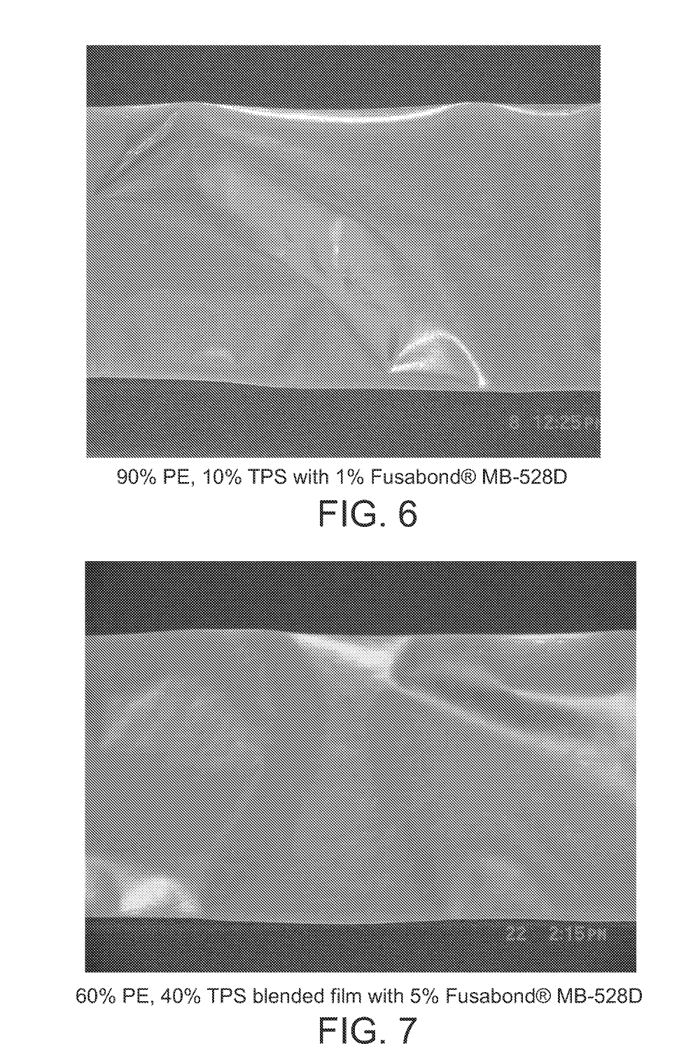

An example of a film made according to the present invention is shown in FIG. 6, which contains about 90% PE, 10% TPS blended with 1% Fusabond® MB-528D, a compatibilizer. The compatibilizer helps the TPS fully disperse into the polyolefin blend. The undispersed TPS that was previously seen in the films is nonexistent, since the starch has been fully dispersed into the polyethylene. Another example is the film shown in FIG. 7, which contains about 60% PE, 40% TPS blended with 5% Fusabond® MB-528D. Similar to FIG. 6, the film showed little evidence of undispersed starch aggregates and no holes. The starch was fully homogenized up to 40%.

The graft copolymer of polyethylene and maleic anhydride appears to better compatibilize blends when a blended resin was made from a ZSK-30 twin screw extruder. In comparison, dry blends with the compatibilizer did not give the same homogenization as the compounded resin. The dry blends are placed directly into the hopper of a HAAKE single screw extruder, but the machine did not exhibit the same shear provided by the twin screws on the ZSK-30 extruder. The twin screw, along with specific mixing capability of on the screws, provides a much more effective mixing of all the ingredients. This same mixing cannot be accomplished on the HAAKE.

### C. Dispersion

When the graft copolymer of polyethylene and maleic anhydride, Fusabond® MB-528D, disperses the TPS, it does so partially by chemical reaction. Therefore, a stoichiometric amount of Fusabond® MB-528D will provide ample homogenization to the film. Generally, the more TPS content that is added in the blend, the more Fusabond® MB-528D needs to be added to provide sufficient bonding sites for the hydroxyl groups of the starch molecule. When different Fusabond® MB-528D ratios are tried, two types of undispersed polymer aggregates tend to form: TPS aggregates, which are yellowish accumulations of thermoplastic starch in the film, and Fusabond® MB-528D aggregates. The second aggregates form when too much Fusabond® MB-528D is added to the film; the Fusabond® will not be fully dispersed. A control was prepared to show this effect. LLDPE was mixed with Fusabond® MB-528D at 2.5%. The film produced showed clear polymer aggregates and streaks, which is a sign of unreacted Fusabond®. For each particular ratio of PE to TPS, there is a specific amount of compatibilizer Fusabond® that will provide successful dispersion for all the film's components.

According to the present invention, the amount of polyoelfin and compatibilizer, respectively, present in the composition can be expressed as a ratio of between about 7.5:1 or 8:1 to about 90:1 or 95:1, or any combination or permutation of ratio values there between. Alternatively, the ratio may be, for instance, between about 10:1 or 12:1 to about 60:1 or 70:1, or preferably between about 15:1 or 17:1 to about 50:1 or 55:1, or more preferably between about 20:1 or 22:1 to about 40:1 or 45:1 (e.g., 25:1, 27:1, 30:1, 33:1, or 35:1).

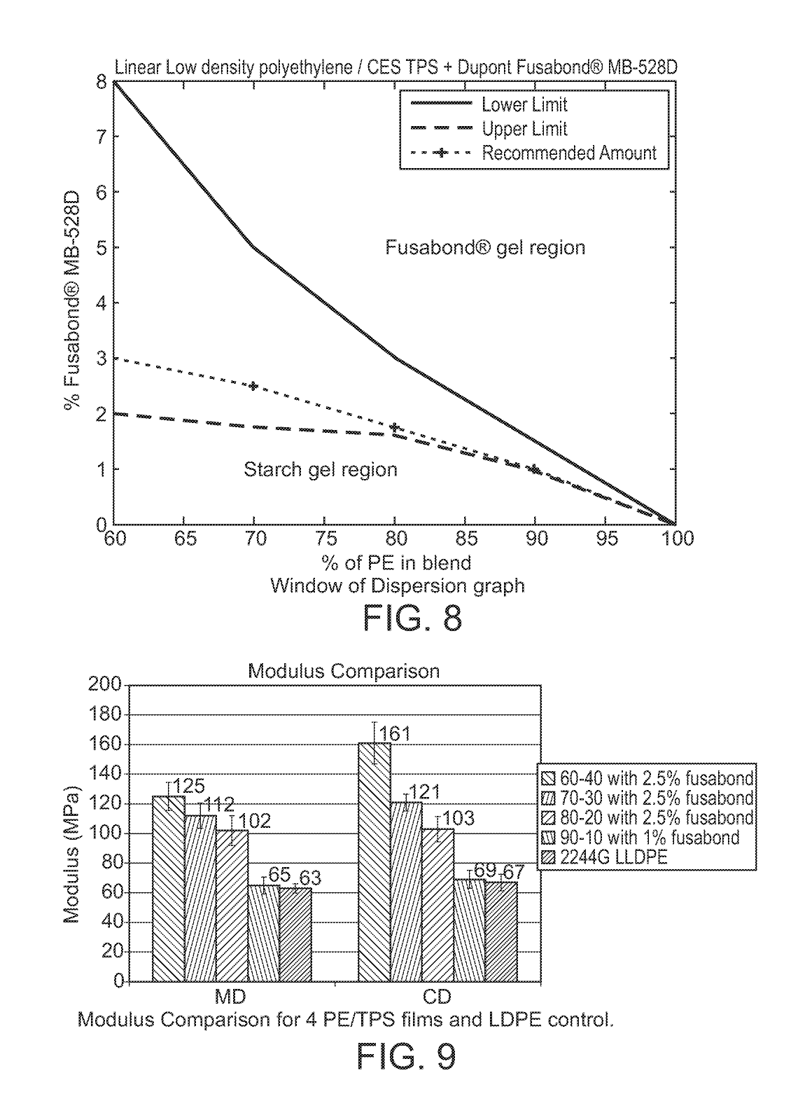

FIG. 8 is a graph that shows the dispersion region for relative incorporated amounts of compatibilizer (Fusabond®) as a function of the polyolefin content in several different blends. The upper and lower solid lines represent the respective upper and lower limits of compatibilizer solubility. The region between the upper and the lower solid lines represents the acceptable zone in which the compatibilizer can be incorporated with best results. In other words, if the amount of compatibilizer added is greater than that of the upper limit line, the compatibilizer will not disperse evenly throughout the blend composition. If the compatibilizer content is less than that of the lower limit line, then regions of undispersed thermoplastic starch particles will tend to aggregate in the film. The dashed line within the acceptable region represents the relative percentage of compatibilizer that will tend to make the best quality films according to the present invention.

### D. Physical Properties of Polymeric Film

The polymeric films are subjected to tensile testing to evaluate their physical properties. FIG. 9, shows the moduli of five films with different levels of TPS incorporation. There are two sets of data on these graphs because there are two directions to test on the film. MD is the machine direction, and that is the direction that is parallel with the film movement exiting the extruder. CD is the cross direction which is perpendicular to the direction of film movement. In both directions (MD and CD), the film became more rigid as more TPS was incorporated. Thermoplastic starch is inherently very brittle and its molecular structure determines its low flexibility. Therefore, the more TPS in the blend, the more rigid it is expected to be. When up to 40% TPS was added, the modulus in both directions more than doubled that of the control, LLDPE. Also, there was little difference between the control and the 90/10 PE/TPS blend data. This showed that when a small amount of TPS added to the film, it had little effect. Once up to 20% TPS was added, there was a large jump in the modulus. Even with this modulus increase, the films were still relatively soft.

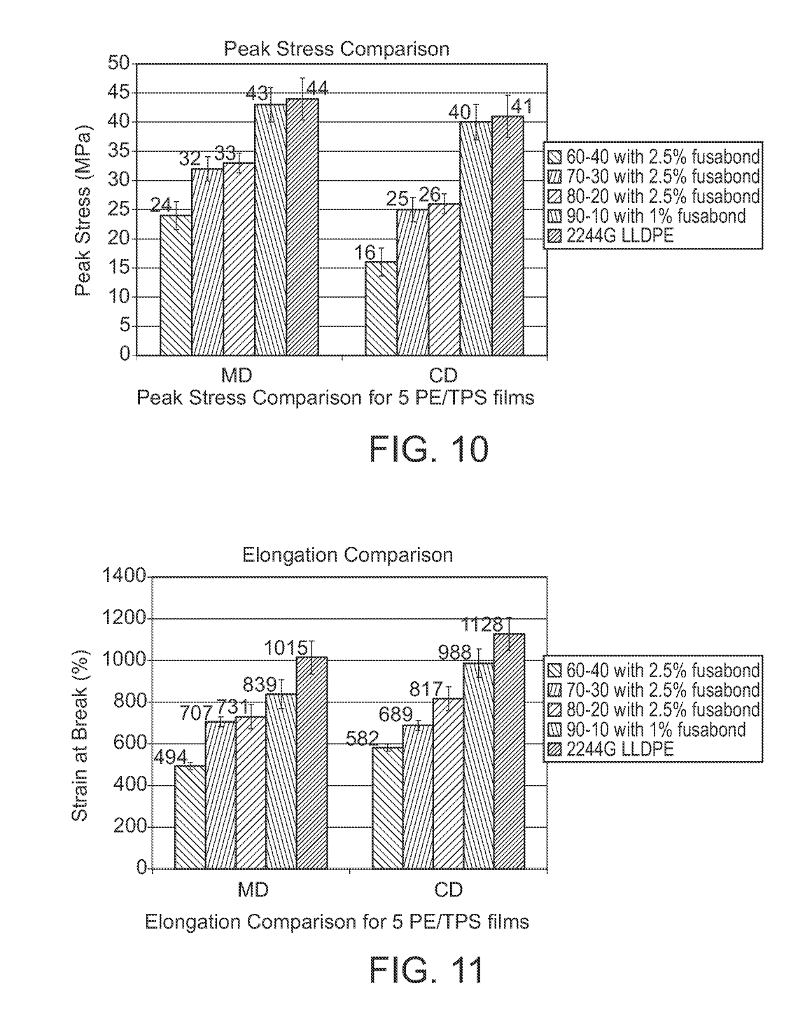

FIG. 10, shows the peak stress of the same five films as in FIG. 9. Again, the 90/10 blend is very close to the control. As more TPS was added into the film, the film became weaker. This is due to the fact that starch, again, does not make a very strong, flexible plastic film. The 60/40 blend in both directions was approximately half as strong as the LLDPE film control.

FIG. 11 shows the elongation of these five film samples from FIGS. 9 and 10. As more TPS was added to the LLDPE, the film's elongation-at-break decrease. The elongation for the 90/10 blend was not as close to the control as the previous data has shown. Its elongation however was still very high. There was a general constant difference between the each blend as 10% more starch is added. At 30 and 40% starch, the elongation was around two-thirds to one-half the elongation of the LLDPE control. These two blends' physical data were substantially low when comparing it to LLDPE control film. These elongations of 500-700%, although much lower than the LLDPE control film data, were still significantly high to be useful for other packaging film applications.

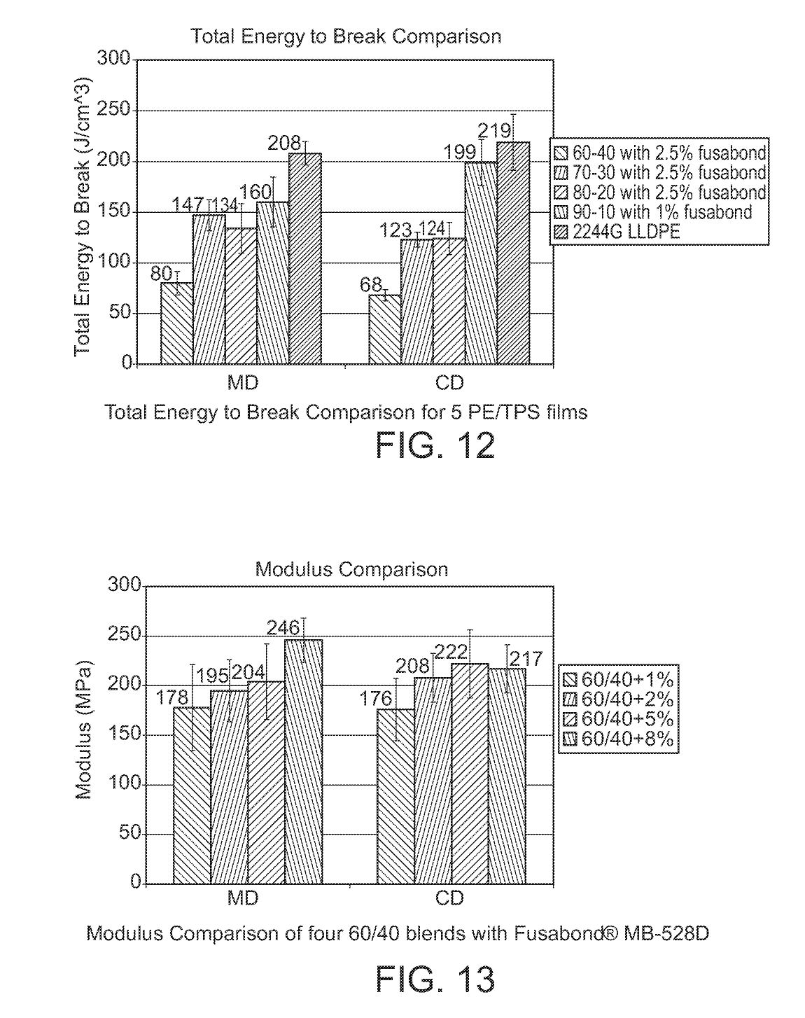

FIG. 12 shows the energy required to break of the partially renewable films along machine direction (MD) and cross-direction (CD) stretching. Significantly less energy was required to break the blends starting at 20% thermoplastic starch. This was in direct proportion to the peak stress graph (FIG. 9). The magnitude of the 80/20 and 70/30 blends were very similar in both graphs, and there was a large drop in the 60/40 blend.

### E. Effect of Compatibilizer on Physical Properties of Films

Adding Fusabond® MB-528D as a compatibilizer has effects on the physical properties of the film. It chemically bonds the grafted LLDPE to the TPS. The more bonds that are formed in the film, the more rigid the film will become. The effects of this compatibilizer can be seen from the following tensile data.

FIG. 13 shows the moduli of four 60% PE, 40% TPS films that were blended with different percentage amounts of compatibilizer (Fusabond® MB-528D). Each ratio is shown in the legend. As more compatibilizer was added, the more rigid the film became due to increased level of reaction. The green bar with 1% Fusabond® MB-528D is much softer than the middle two blends. This ratio, however, was not in the window of dispersion, and therefore it is not a recommended blend. The 8% compatibilizer blend did not possess any undispersed polymer, however this blend film was too rigid and expensive to be considered a possible partially renewable film candidate.

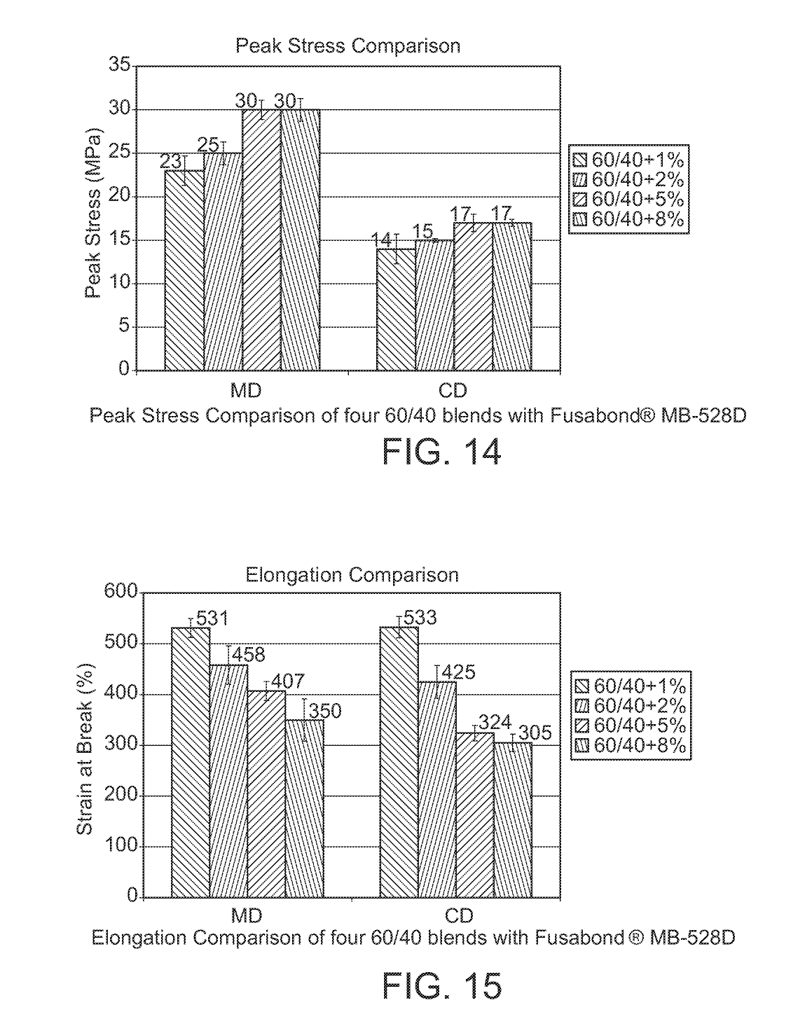

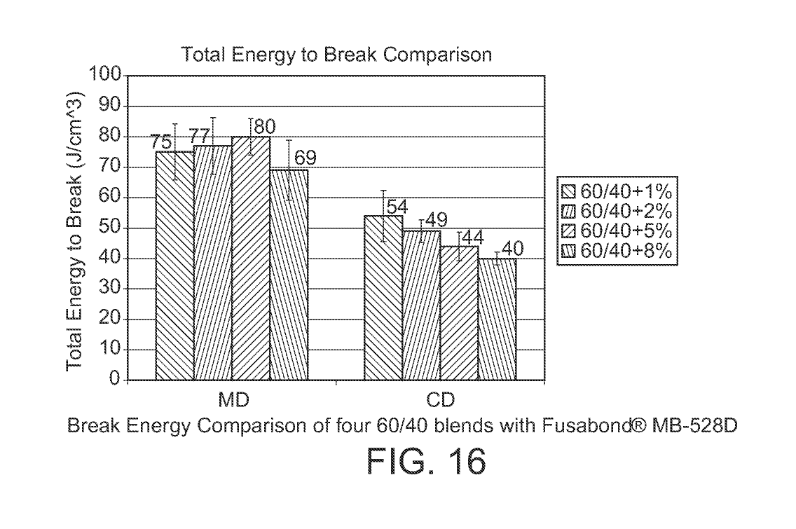

FIG. 14 is a graph that shows the peak stresses of these same four blends. Similar in trend, the strength of the film was increased as more Fusabond® MB-528D was added to the film. FIG. 15 is a graph that summarizes the relative comparative elongation of the four blends of FIG. 13. As the films become more rigid, they do not stretch as far. There was a significant difference in the film properties when the amount of Fusabond® MB-528D is at 1 wt. % versus at 8 wt. %. The 60/40 blend at 1 wt. % did not disperse all the starch throughout the film, so the undispersed thermoplastic starch did not become part of the film. Undispersed aggregates have a tendency to weaken the film when stretched. At higher concentrations (e.g., ≧5 wt. %), the film is observably more flexible and pliant. The graph shows that the lower the amount of compatibilizer and starch that is mixed with the PE, the more it becomes like the control sample, which is pure PE, since proportionately, the PE phase is a more dominant component in the polymer matrix than the compatiblizer in terms of contribution to the films' properties. Nonetheless, even with a small amount (e.g., ˜1-2%) mixed in the blend, as shown, the film exhibited a more flexible and uniform appearance than without the compatibilizer. FIG. 16 is a graph that shows the break energy of these films. In the cross direction, less energy was required to break the film as the amount of the compatibilizer is increased.

### F. Illustrative Consumer Product

The present thermoplastic film materials can be used to make packaging for various kinds of consumer products in general terms. For purpose of illustration, certain package embodiments may be for consumer products such as absorbent articles (e.g., baby diapers or feminine hygiene articles). The package can have one or more absorbent articles disposed therein. As used herein, the term “absorbent article” refers to devices that absorb and/or contain a substance, such as, e.g., body exudates. A typical absorbent article can be placed against or in proximity to the body of the wearer to absorb and contain various body excretions. As used herein, the term “feminine hygiene article” refers to articles such as, e.g., disposable absorbent articles that can be worn by women for menstrual and/or light incontinence control, such as, for example, sanitary napkins, tampons, interlabial products, incontinence articles, and liners. As used herein, the term “feminine hygiene article” can also refer to other articles for use in the pudendal region such as, e.g., wipes and/or powder. As used herein, a feminine hygiene article can include any associated wrapping or applicator that typically can be associated with the feminine hygiene article. For example, a feminine hygiene article can be a tampon that may or may not include an applicator and/or can be a sanitary napkin that may or may not include a wrapper, such as, e.g., a wrapper that individually encloses the sanitary napkin. Feminine hygiene articles do not include baby diapers.

### Section III—Empirical

### A. Materials

### Dowlex 2244G Polyethylene Resin

Linear low density polyethylene produced by The Dow Chemical Company, Midland, Mich. This resin was used as the main, nonrenewable component of the partially renewable films.

### Cornstarch

Produced by Cargill, Inc. Hammond, Ind. This was the native cornstarch source used to produce the homemade TPS.

### D-Sorbitol

Plasticizer purchased from Sigma-Aldrich, St. Louis, Mo. Sorbitol was used at 30% along with cornstarch while compounding the thermoplastic starch.

### Excel P-40S

Surfactant produced by The Kao Corporation, Tokyo, Japan. Surfactant was added at 2% to lubricate the polymer and reduce torque on the extruder screws.

### DuPont Fusabond® MB-528D

Compatibilizer produced by DuPont Canada Company, Mississauga, Ontario. Fusabond® MB-528D is >99% maleic anhydride modified polyethylene (LLDPE). Used as a compatibilizer.

### Escorene® Ultra Ethylene Vinyl Acetate

Produced by ExxonMobil Chemical Company, Houston, Tex. EVA was tried as a potential compatibilizer. It contained <0.2% vinyl acetate.

### Ethylene Vinyl Alcohol Copolymer

Produced by EVAL Company of America, Houston, Tex. This is a copolymer of ethylene and vinyl alcohol via EVA.

### B. Compounding

Blended resins are made on the ZSK-30 Twin Screw Extruder. TPS was fed by one feeder and a blend of 2244G LLDPE and Fusabond® MB-528D were fed by another. The dry blend of LLDPE and Fusabond® MB-528D was prepared by the addition of compatibilizer such that when fully mixed with TPS, the desired ratio was obtained.

The TPS was often fed by Feeder 2 and the LLDPE/ Fusabond® blend was fed by Feeder 3. The ZSK-30 ran at 20 lbs/hr. For 90/10 blends, Feeder 2 was set to 2 lbs/hr and Feeder 3 was set to 18 lbs/ hr. The ratios of mass flow rates were adjusted to give the desired ratio of LLDPE and TPS while keeping the overall flow rate of 20 lbs/hr. The temperature profile on the ZSK-30 extruder is shown in Table 1.

TABLE 1
Temperature profile on ZSK-30 for blends

| | Temp |
|---|---|
| Zone | (° C.) |
| 1 | 100 |
| 2 | 130 |
| 3 | 175 |
| 4 | 175 |
| 5 | 175 |
| 6 | 175 |
| 7 | 175 |

The melting temperature, Tₘ=197° C., which was approximate for all blends. The pressure ranged from 350-500 psi and torque from 60-80%. The compounding screw and a 3-hole die were used for every trial. The screw speed was set to 200 rpm. The resin strands produced by the ZSK-30 were cooled on a cooling belt by a series of fans. Once the resin had cooled, it was pelletized and placed in a bag for shipping.

The processing conditions for TPS alone are different than that for the LLDPE/TPS blending. The temperature profile on the ZSK-30 extruder is shown in Table 2.

TABLE 2
Temperature profile on ZSK-30 for TPS

| | Temp |
|---|---|
| Zone | (° C.) |
| 1 | 95 |
| 2 | 110 |
| 3 | 115 |
| 4 | 120 |
| 5 | 120 |
| 6 | 120 |
| 7 | 115 |

The screw speed was set to 150 rpm and the pressure ranged from 700-1300 psi. The melting temperature, Tm was 130° C. and the torque ranged from 30-47%. The powder feeder was used and ran at 20 lbs/hr. A nip was used to draw down the stands of the TPS before being pelletized.

### C. Film Casting

All films were cast on the HAAKE Rheomex 252 Single Screw Extruder. A chill roll was used to cool the polymer as it came from the cast film die and to flatten it out to form the film. The processing conditions for the extruder were the same for all films cast. They were as follows is shown in Table 3.

TABLE 3
Temperature profile on HAAKE for film casting

| | Temp |
|---|---|
| Zone | (° C.) |
| 1 | 150 |
| 2 | 160 |
| 3 | 170 |
| 4 | 170 |
| 5 | 150 |

The screw speed was set to 50-60 rpm. The pressure was kept around 1000 psi and the torque ranged between 3000-4000 m·g. The chill roll settings were adjusted as needed to obtain films with a gauge of 2.0 mil. If the film was too thick, the chill roll was sped up to draw the polymer out of the die faster, making a thinner film. If the film was too thin, the chill roll was slowed down.

The HAAKE extruder has fewer temperature zones than the ZSK-30 extruder. This is because the ZSK-30 has much longer screws than the HAAKE, so more zones are needed to obtain the same accuracy of the temperature distribution.

### D. Dispersion Window

Each data point on the graph in FIG. 8, represents a film that was cast in the lab. If the film had no undispersed polymer, that ratio was placed in the window of dispersion. If clear polymer aggregates were seen, that blend was placed outside the window. Similarly, if yellow aggregates were seen, that means the starch was not fully dispersed, and the blend was placed outside the window. Approximately four blend ratios were tried for each PE amount (60%, 70%, 80%, and 90%). The control, LLDPE, did not contain any other components, and thus did not require a compatibilizer. Judging these blends by eye gave these data points. The lines were drawn at the ratio in which the undispersed polymer became visible. The recommended amount line was developed by taking two factors into consideration: pricing and dispersion.

The upper limit for the 60/40 blend was never reached. Fusabond® MB-528D was added in no higher than 8%. Undispersed Fusabond® may not be visible due to the high amount of starch present in the blend. The starch hydroxyls were still able to provide a linking spot to the maleic anhydride, even though the starch was fully dispersed. At this point on the graph, the upper limit was more of a factor of price than success of homogenization.

### E. Tensile Property Test

All tensile properties were tested on the MTS Sintech 1/D tensile testing apparatus. Samples were prepared for testing by taking a portion of the film, and cutting 5 dog-bone shaped samples in each direction (i.e., machine direction (MD) and cross-machine direction (CD)). The test length of each dog-bone was 18 mm, the width of the test area was 3 mm, and the thickness varied about 2 mil. Each dog-bone was tested separately. During the test, samples were stretched at a crosshead speed of 5.0 inches/minute until breakage occurred. The computer program TestWorks 4 collected data points during the testing and generated a stress (MPa) versus strain (%) curve from which a variety of properties were determined: modulus, peak stress, elongation, and toughness.

### Empirical Testing

### COMPARATIVE EXAMPLE 1

A mixture of 60% of a thermoplastic starch masterbatch (BL-F, produced by Biograde, Nanjing, China), 32% of a linear low density polyethylene (LLDPE) (melt flow rate of 1 and density of 0.918 g/cc, Grade 118 W, supplied by SABIC), and 8% white master batch (Shanghai Ngai Hing Plastic Materials Co., Ltd.) was fed to a three-layer multi-layer blown film line. The extruders had a screw diameter of 250 mm, and a Length/Diameter of 30/1. The die gap was 2.2 mm.

The film extrusion conditions are listed in the following table:

| Temperature | Screw | Screw | Screw | Screw | |
|---|---|---|---|---|---|
| (° C.) | Section I | Section II | Section III | Section IV | Die |
| Outer-layer | 155 | 165 | 165 | 164 | 165 |
| Middle-layer | 155 | 165 | 165 | 165 | 160 |
| Inner-tier | 155 | 165 | 165 | 165 | 160 |

Unlike conventional polyethylene-based films, biodegradable polymeric films according to the present invention exhibit a more micro-textured surface.

1. Tensile Test Results:

| | Tensile | Tensile | % Elongation | % Elongation |
|---|---|---|---|---|
| | Strength MD | Strength CD | at Break Point | at Break Point |
| | (N/15 mm) | (N/15 mm) | MD | CD |
| Tensile | 12 | 14 | 213 | 16 |
| Test | | | | |

The tensile properties of the comparative films were very poor for packaging film applications. The film ripped easily.

### EXAMPLE 1

A mixture of 17% of a thermoplastic starch masterbatch (BL-F, produced by Biograde, Nanjing, China), 38% of a linear low density polyethylene (LLDPE) (melt flow rate of 1 and density of 0.918 g/cc, Grade 118 W, supplied by SABIC) and 38% low density polyethylene (LDPE) (melt flow rate of 2.8 g/10 min and density: 0.925, Grade: Q281, supplied by SINOPEC Shanghai, Shanghai, China), and 7% white master batch (Shanghai Ngai Hing Plastic Materials Co., Ltd.) was fed to a single screw extruder blown film machine, the screw diameter was 150 mm, the Length/Diameter was 30/1. The die gap was 1.8 mm.

The other process conditions are listed in the following table:

| | NO. 8 | NO. 7 | NO. 6 | NO. 5 | NO. 4 | NO. 3 | NO. 2 | |
|---|---|---|---|---|---|---|---|---|
| | HEATER | HEATER | HEATER | HEATER | HEATER | HEATER | HEATER | Die Temperature |
| Temperature | (° C.) | (° C.) | (° C.) | (° C.) | (° C.) | (° C.) | (° C.) | (° C.) |
| Example 1 | 180 | 180 | 180 | 173 | 164 | 160.1 | 146.5 | 184 |
| Example 2 | 180 | 180 | 180 | 173 | 164 | 160.1 | 146.5 | 180 |
| Example 3 | 180 | 180 | 180 | 173 | 164 | 160.1 | 146.5 | 180 |

### EXAMPLE 2

A mixture of 37% of a thermoplastic starch masterbatch (BL-F, produced by Biograde, Nanjing, China), 28% of a linear low density polyethylene (LLDPE) (melt flow rate of 1 and density of 0.918 g/cc, Grade 118 W, supplied by SABIC) and 28% low density polyethylene (LDPE) (melt flow rate of 2.8 g/10 min and density: 0.925, Grade Q281, supplied by SINOPEC Shanghai, Shanghai, China), and 7% white master batch (Shanghai Ngai Hing Plastic Materials Co., Ltd.) was fed to a single single screw extruder blown film machine, the screw diameter was 150 mm, the Length/Diameter was 30/1. The gap was 1.8 mm.

### EXAMPLE 3

A mixture of 57% of a thermoplastic starch masterbatch (BL-F, produced by Biograde, Nanjing, China), 18% of a linear low density polyethylene (LLDPE) (melt flow rate of 1 and density of 0.918 g/cc, Grade 118 W, supplied by SABIC) and 18% low density polyethylene (LDPE) (melt flow rate of 2.8 g/10 min and density: 0.925, Grade: Q281, supplied by SINOPEC Shanghai, Shanghai, China), and 7% white master batch (Shanghai Ngai Hing Plastic Materials Co., Ltd.) was fed to a single screw extruder blown film machine, the screw diameter was 150 mm, the Length/Diameter was 30/1. The die gap was 1.8 mm.

### Blowing Machine Condition:

The process conditions of the blown film extruder are summarized as follows:

| | NO. 8 | NO. 7 | NO. 6 | NO. 5 | NO. 4 | NO. 3 | NO. 2 | Die |
|---|---|---|---|---|---|---|---|---|
| | HEATER | HEATER | HEATER | HEATER | HEATER | HEATER | HEATER | Temperature |
| Temperature | (° C.) | (° C.) | (° C.) | (° C.) | (° C.) | (° C.) | (° C.) | (° C.) |
| Example 1 | 180 | 180 | 180 | 173 | 164 | 160 | 147 | 184 |
| Example 2 | 180 | 180 | 180 | 173 | 164 | 160 | 147 | 180 |
| Example 3 | 180 | 180 | 180 | 173 | 164 | 160 | 147 | 180 |

All the films from Examples 1, 2, and 3 were printed with conventional dyes/inks used in packaging. The printing quality of Example 1 appeared to be the best. These films were also converted into product bags for absorbent products, and no physical or visual issues were encountered. The winding tension was reduced from 10.6 kgf to 6.1 kgf to overcome wrinkle issues. Mechanical and other physical testing were performed, the results were listed in the following tables:

| | Tensile | Tensile | | |
|---|---|---|---|---|
| | Strength | Strength | % Elongation | % Elongation |
| | MD | CD | at Break Point | at Break Point |
| | (N/25.4 mm) | (N/25.4 mm) | MD | CD |
| Example 1 | 28.7 | 26.5 | 687 | 735 |
| Example 2 | 24.1 | 20.4 | 591 | 624 |
| Example 3 | 18.4 | 15.5 | 316 | 214 |

### Printed Dots Loss in a Printing Test:

The printed film in Example 2 after being subjected to an ink loss test, the results are listed in the following table:

| | Original Dot Design | | | | | | |
|---|---|---|---|---|---|---|---|
| | 100% | 90% | 80% | 75% | 70% | 60% | 50% |
| Loss % | 0 | 0 | 5 | 7 | 10 | 15 | 20 |
| | Original Dot Design | | | | | | |
| | 40% | 30% | 25% | 20% | 15% | 10% | 5% |
| Loss % | 30 | 50 | 60 | 70 | 80 | 90 | 100 |

### Rapid Aging Test (RAT):

### Test Condition

| | | Testing | Tested | |
|---|---|---|---|---|
| | Test condition | Equipment | samples | Test Period |
| RAT I | 54-47° C. | oven | Example 1 | 14 days |
| | 54-47° C. | oven | Example 2 | 14 days |
| RAT II | 37-40° C. | oven | Example 1 | 3 months |
| | 37-40° C. | oven | Example 2 | 3 months |
| RAT III | 54-47° C., >75% | CTCH | Example 1 | 14 days |
| | Relative | | | |
| | Humidity | | | |
| | 54-47° C., >75% | CTCH | Example 2 | 14 days |
| | RH | | | |
| RAT IV | 37-40° C., >75% | CTCH | Example 1 | 3 months |
| | RH | | | |
| | 37-40° C., >75% | CTCH | Example 2 | 3 months |
| | RH | | | |

Note:
CTCH: Constant temperature and constant humidity.

### Mechanical Test Results:

| | Tensile | | | % |
|---|---|---|---|---|
| | Strength | Tensile | % Elongation | Elongation |
| | MD | Strength CD | at Break Point | at Break |
| Performance | (N/25.4 mm) | (N/25.4 mm) | MD | Point CD |
| RAT I-80% | 28.3 | 26.0 | 695 | 663 |
| RAT I-60% | 20.8 | 19.7 | 348 | 270 |
| RAT II-80% | 27.5 | 24.0 | 675 | 696 |
| RAT II-60% | 21.1 | 18.3 | 451 | 467 |
| RAT III-80% | 24.2 | 29.2 | 692 | 712 |
| RAT III-60% | 22.3 | 22.3 | 338 | 201 |
| RAT IV-80% | 25.0 | 30.5 | 718 | 726 |
| RAT IV-60% | 20.2 | 31.4 | 303 | 424 |

### Submersion Test:

Considering the bio-degradable film package will be stored or used in places with high humidity, such as lavatories or bathrooms, a hot water vapor and/or liquid submersion test was conducted to test how well the films may withstand liquid water or water vapor. Since the bio-degradable films according to the present invention contain starch that is water soluble, it was expected that the tensile strength of the films would be easier to compromise when exposed to or immersed in water. The results are summarized in the following tables. A finding of interest is that the MD/CD tensile strength and elogation percentage values are even better that those samples that were not subjected to the water vapor or liquid immersion.

### Test Condition

| | | Testing | | Test |
|---|---|---|---|---|
| | Test condition | Equipment | Tested samples | Period |
| Test I | 20° C. | Container | 55 μm: Example 1 | 24 hours |
| | water steam | | 45 μm: Example 1 | |
| Test II | 20° C. | Container | 55 μm: Example 1 | 24 hours |
| | 9% salt aqueous | | 45 μm: Example 1 | |
| | solution | | | |

### Performance Test Result

| | Tensile | Tensile | % | % |
|---|---|---|---|---|
| | Strength | Strength | Elongation at | Elongation at |
| | MD | CD | Break Point | Break Point |
| Performance | (N/25.4 mm) | (N/25.4 mm) | MD | CD |
| Test I-55 μm | 31.2 | 31.3 | 652 | 648 |
| Test I-45 μm | 25.3 | 25.8 | 590 | 580 |
| Test II-55 μm | 25.8 | 24.8 | 719 | 689 |
| Test II-45 μm | 20.9 | 20.2 | 650 | 639 |

As one incorporates more corn resin into the blend the films become more bio-degradable. Even though embodiments of the present film materials that have a heightened level of starch within will tend to have rougher film surfaces (on a micron scale) than other polyolefin-based packaging film materials, any difference in appearance of finely printed designs or pattern details are virtually imperceptible to the naked eye. Mechanical performance of the film is within commercially tolerances. Favored features of certain film embodiments (e.g., Example 1) have a natural matt gross finish and convey to the touch a soft feeling that is preferred by consumers.

The present invention has been described in general and in detail by way of examples. Persons of skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein.

We claim:

1. A flexible polymeric film comprising: from about 5% to about 45% of a thermoplastic starch (TPS), from about 55% to about 95% of a polyolefin or mixtures of polyolefins, and from about 0.5% to about 8% of a compatibilizer, which has a non-polar backbone and a polar functional monomer or a block copolymer of both the non-polar block and a polar block, or a random copolymer of a polar monomer and non-polar monomer.

2. The polymeric film according to claim 1, wherein the amounts of said thermoplastic starch and compatibilizer, respectively, are present in a ratio of between about 7.5:1 to about 95:1, desirably between about 10:1 and about 55:1, or between about 15:1 and about 50:1.

3. The polymeric film according to any one of the foregoing claims, wherein the thermoplastic starch comprises a native starch or a modified starch with a plasticizer;
wherein said native starch is selected from corn, wheat, potato, rice, tapioca, cassava;
wherein said modified starch is a starch ester, starch ether, oxidized starch, hydrolyzed starch, hydroxyalkylated starch; and wherein said a plasticizer or mixture of two or more plasticizers selected from polyhydric alcohols including glycerol, glycerine, ethylene glycol, polyethylene glycol, sorbitol, citric acid and citrate, or aminoethanol.

4. The polymeric film according to claim 3, wherein the thermoplastic starch comprises from about 55 to 95% starch and from 5 to 45% plasticizers, and optionally 0.5 to 5% of surfactant.

5. The polymeric film according to any one of the foregoing claims, wherein said polyolefins include: low-density polyethylene, high-density polyethylene, linear low-density polyethylene, polyolefin elastomers, ethylene copolymers with vinyl acetate, or methacrylate.

6. The polymeric film according to any one of the foregoing claims, wherein said compatibilizer includes: ethylene vinyl acetate copolymer (EVA), ethylene vinyl alcohol copolymer (EVOH), ethylene acrylic acid (EAA), and a graft copolymer of polyethylene and maleic anhydride.

7. The polymeric film according to any one of the foregoing claims, wherein said polar functional monomer includes: maleic anhydride, acrylic acid, vinyl acetate, vinyl alcohol, amino, amide, or acrylate, and is present in an amount from 0.1 to 40% by weight.

8. The polymeric film according to any one of the foregoing claims, wherein a mineral filler that includes: talcum, calcium carbonate, magnesium carbonate, clay, silica, alumina, boron oxide, titanium oxide, cerium oxide, or germanium oxide, and is present in an amount from about 5% to about 35% by weight.

9. The polymeric flexible film according to any one of the foregoing claims, wherein the said film has a thickness from about 10 micrometers to about 100 micrometers, desirably from about 15 micrometer to about 35 micrometers.

10. The polymeric flexible film according to any one of the foregoing claims, wherein the film has a modulus from about 50 MPa to about 300 Mpa, a peak stress ranges from about 15 MPa to about 50 MPa, at an elongation of from about 200% to about 1000% from original dimensions.

11. The polymer film according to any one of the foregoing claims, wherein said film has a micro-textured surface with topographic features of between about 0.5 microns to about 8 microns.

12. A flexible polymeric film comprising: from about 5% to about 45% of a thermoplastic starch concentrate or masterbatch, and from about 40% to 55% of a polyolefin or mixtures of polyolefins, and from about 1% to about 15% of a color concentrate.

13. The polymeric flexible film of claim 12, wherein the starch concentrate comprises from about 50% to 90% of starch, about 0.5% to about 25% of a of a polyolefin or mixtures of polyolefins, and about 0.5% to about 8% of a compatibilizer, which has a non-polar backbone and a polar functional monomer or a block copolymer of both the non-polar block and a polar block, or a random copolymer of a polar monomer and non-polar monomer.

14. A packaging assembly for a consumer product, said packaging comprising at least a portion made from a polymeric film according to any one of the foregoing claims.

15. A consumer product comprising a portion made with a flexible polymeric film according to any one of the preceding claims, wherein said consumer product is an absorbent article including diapers, pantiliners, feminine pads, adult incontinence products, wipers, or tissues.

16. A consumer product according to either claim 14 or 15, wherein said polymeric film includes from about 5% to about 45% of a thermoplastic starch (TPS), from about 55% to about 95% of a polyolefin or mixtures of polyolefins, and from about 0.5% to about 8% of a compatibilizer, which has a non-polar backbone and a polar functional monomer or a block copolymer of both the non-polar block and a polar block or a random copolymer of polar monomer and non-polar monomer, the amounts of said thermoplastic starch and compatibilizer, respectively, are present in a ratio of between about 7.5:1 to about 95:1.

17. A method of forming a polymeric film, the method comprising: preparing a polyolefin mixture, blending said polyolefin mixture with a thermoplastic starch and a compatibilizer, which has a non-polar backbone and a polar functional monomer or a block copolymer of both the non-polar block and a polar block or random copolymer, said thermoplastic starch and compatibilizer, respectively, are present in amounts in a ratio of between about 7.5:1 to about 95:1; extruding said a film of said blended polyolefin mixture.

18. The method according to claim 17, wherein said compatibilizer has a non-polar backbone and a polar functional monomer or a block copolymer of both the non-polar block and a polar block.

19. The method according to claim 18, wherein said compatibilizer is a graft copolymer of polyethylene and maleic anhydride.

20. A method of forming a packaging assembly, the method comprising: preparing a polyolefin mixture, blending said polyolefin mixture with a starch concentrate, said starch concentrate and polyolefins, respectively, are present in amounts in a ratio of between about 1:1 to about 0.1:1; and extruding a film of said blended polyolefin mixture according to any one of claims 17-19.
